(19) United States
(12) Patent Application Publication
(10) Pub. No.: US 2015/0145650 A1
(43) Pub. Date: May 28, 2015

(54) METHOD, SOFTWARE APPLICATION, AND SYSTEM FOR TRACKING PACKAGES BY GLOBAL POSITIONING SYSTEM (GPS)

(71) Applicants: Michael Adam Levan, Lewisburg, PA (US); David Matthew Capatch, Lewisburg, PA (US)

(72) Inventors: Michael Adam Levan, Lewisburg, PA (US); David Matthew Capatch, Lewisburg, PA (US)

(21) Appl. No.: 14/092,885

(22) Filed: Nov. 27, 2013

(51) Int. Cl. G06K 7/10

(52) U.S. Cl. CPC G06K 7/10
USPC 340/10.1

(57) ABSTRACT

A system according to various embodiments can include a reusable tracking device associated with a shipment of a package and an input/output device. The reusable tracking device is configured to be separable from the package and returned for reuse when the package reaches a predefined destination. The tracking device comprises a sensor, memory, and a processor. The sensor detects sensor data about the reusable tracking device. The memory stores data including the sensor data collected by the sensor. The processor associated with the reusable tracking device determines a location of the reusable tracking device based on the data. The input/output device receives the data from the reusable tracking device.

### I. FIELD OF THE INVENTION

The present disclosure relates generally to the field of a location tracking system. More particularly, the present disclosure relates to a system for constantly monitoring and tracking the shipment of a package, which is accompanied by a recoverable tracking device throughout the package's journey.

### II. BACKGROUND OF THE INVENTION

With the advancements and innovations in the shipping industry, electronic tracking systems have exploded in popularity to enable a user to track the delivery of a package. However, conventional systems and methods do not allow for the constant tracking of the current location of a package. Rather, current tracking systems and methods only provide incremental updates and estimated delivery times. The incremental updates do not provide a complete picture of the shipment's journey. For example, conventional systems may be limited to providing data regarding intermittent locations during the package's journey.

In some tracking system, a package may have a bar code attached to the package and the bar code corresponds to a tracking number for that package. Each time the package arrives at a checkpoint or a processing center, the bar code may be scanned. The user may monitor the progress of the package during shipment by accessing a website and providing the tracking number assigned to the package. These systems may only inform the user that the package has transitioned through specific locations on its journey, but does not provide real-time information about the package while travelling the entire journey. These incremental shipment updates may not be provided to the customer frequently enough. Shipment senders and receivers do not have an effective way to jointly view and recall location information about a shipment.

Furthermore, with the conventional systems, estimated delivery times also do not provide enough information to the user. In addition, if any tracking hardware, such as used in a sensor-based tracking system, is associated with the delivery of the package, recovery of the tracking hardware is difficult. Such tracking hardware systems can also be expensive.

Accordingly, there is a need to provide a tracking system that continuously monitors the current location of the package and provides real-time tracking data about a shipment. There also is a need to provide an easy method of returning the tracking device after the shipment has reached its destination.

### III. SUMMARY OF THE INVENTION

A system according to various exemplary embodiments can include a reusable tracking device associated with a shipment of a package and an input/output device. The reusable tracking device is configured to be separable from the package and returned for reuse when the package reaches a predefined destination. The tracking device comprises a sensor, memory, and a processor. The sensor detects sensor data about the reusable tracking device. The memory stores data including the sensor data collected by the sensor. The processor associated with the reusable tracking device determines a location of the reusable tracking device based on the data. The input/output device receives the data from the reusable tracking device.

A method of tracking a package according to various exemplary embodiments can include providing a reusable tracking device associated with a shipment of a package; separating the reusable tracking device from the package and returning the reusable tracking device for reuse when the package reaches a predefined destination; detecting sensor data about the reusable tracking device; storing, in a memory, data collected by the sensor; and determining a location of the reusable tracking device based on the sensor data.

### IV. BRIEF DESCRIPTION OF THE DRAWINGS

FIG. 1 is a block diagram of an exemplary tracking system in accordance with the present teachings;

FIG. 2 depicts an exemplary embodiment of a tracking device in accordance with the present teachings;

FIG. 3 depicts an example of establishing a user's account within the system to request a tracking device in accordance with the present teachings;

FIG. 4 depicts an example of a user receiving the requested tracking device in accordance with the present teachings;

FIG. 5 depicts an example of packaging the tracking device within the shipment to form a pod in accordance with the present teachings;

FIG. 6 depicts an example of transporting the pod to its destination in accordance with the present teachings;

FIG. 7 depicts delivering the pod to the recipient and returning the tracking device in accordance with the present teachings; and

FIG. 8 illustrates an exemplary method for tracking a package throughout its journey in accordance with the present teachings.

The present disclosure may take form in various components and arrangements of components, and in various process operations and arrangements of process operations. The present disclosure is illustrated in the accompanying drawings, throughout which, like reference numerals may indicate corresponding or similar parts in the various figures. The drawings are only for purposes of illustrating preferred embodiments and are not to be construed as limiting the disclosure. Given the following enabling description of the drawings, the novel aspects of the present disclosure should become evident to a person of ordinary skill in the art.

### V. DETAILED DESCRIPTION OF VARIOUS EMBODIMENTS

The following detailed description is merely exemplary in nature and is not intended to limit the applications and uses disclosed herein. Further, there is no intention to be bound by any theory presented in the preceding background or summary or the following detailed description.

Throughout the application, description of various embodiments may use “comprising” language, however, it will be understood by one of skill in the art, that in some specific instances, an embodiment can alternatively be described using the language “consisting essentially of” or “consisting of.”

For purposes of better understanding the present teachings and in no way limit the scope of the teachings, it will be clear to one of skill in the art that the use of the singular includes the plural unless specifically stated otherwise. Therefore, the terms “a,” “an” and “at least one” are used interchangeably in this application.

Various embodiments of the system and method described herein relates to tracking a package during its journey. Various embodiments describe a tracking system that provides continuous real-time data for the sender and receiver regarding the location of the package during its entire journey. This provides users with a complete history of the journey and immediate information regarding where the package is currently located. The system and method also provides more accurate delivery times.

In various embodiments, a tracking device is associated with the package. The tracking device may include a location sensor, such as a GPS or a geo-location device, which collects location data. The system, method and device also dynamically provides information to users based on the package's geo-location. Various embodiments provide an easy method for returning the tracking device after the shipment has reached its destination. The system and method also does not require that the shipment sender recover the tracking hardware. In various embodiments, the tracking device may be in the form of a consumable product configured in the form of a reusable product, which is returned to a warehouse and reprocessed for reuse.

In various embodiments, the location data may be made available to users by, for example, transmitting the data to a server. The user's device, such as computers or handheld devices like smart phones, accesses the network to retrieve the location data. The system and method also allows separate access to the tracking data to the shipper and the receiver.

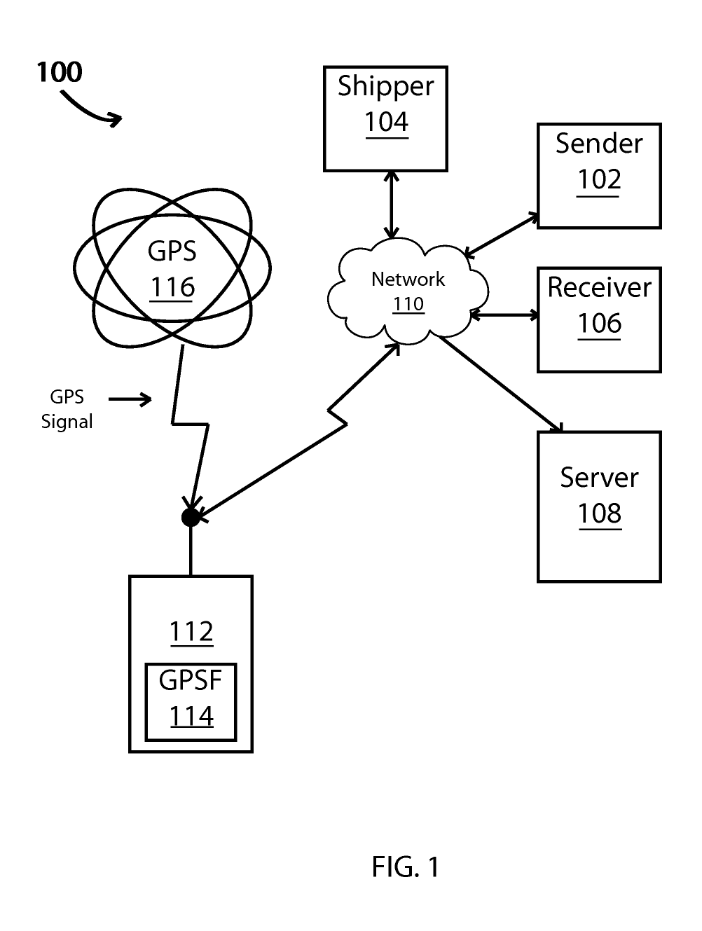

FIG. 1 illustrates an exemplary system 100 for tracking a package and collecting and transmitting data associated with the package during the shipment from its origin to destination. The system 100 may include client devices 102, 104, 106, server 108, network 110, tracking device 112, and a geo-location system 116.

The system 100 comprises a plurality of client devices 102, 104, 106 coupled to a network 110. Examples of the client devices can include a sender device 102, a shipper device 104, and a receiver device 104 having communications capability, a computing platform such as a laptop, palmtop, or tablet, a personal digital assistant, an internet access device, or other similar device, including combinations thereof. Client devices 102, 104, 106 can communicate with the network 110 over at least one communication link. While three client devices are illustrated in communication with the network 110, this is merely exemplary, and a substantially greater number of devices can communicate with the network 110 and each other.

Network 110 may comprise a wireless network, including base stations, wireless communication nodes, telephony switches, internet routers, network gateways, computer systems, communication links, or some other type of communication equipment, and combinations thereof. Wireless data may include, for example, e-mail, Internet access, text messaging, instant messaging, voice transmissions and paging. Network 110 can also comprise a wired communication network comprising processing nodes, routers, gateways, and physical and/or wireless data links for carrying data among various network elements, including combinations thereof, and can include a shared network, a public network, a local area network, a wide area network, an intranet network and an internetwork (including the Internet). Wireless network protocols may comprise code division multiple access (CDMA), time division multiple access (TDMA), Global System for Mobile communications (GSM), Universal Mobile Telecommunications System (UMTS), High-Speed Packet Access (HSPA), Bluetooth networks, Long Term Evolution (LTE), and Radio-Frequency Identification (RFID). Wired network protocols that may be utilized by communication network 110 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). The above list of wireless protocols and wired protocols is merely exemplary and is not an exclusive one.

Tracking device 112 can be directly coupled with network 110. Tracking device 112 can coupled with clients 102, 104, 106 and server 108 via network 110. The tracking device 112 comprises geo-locating functionality for determining the geo-location of the tracking device. For example, the geo-locating functionality may comprise a GPS functionality 114 for accessing the geo-location transmitted signal from a GPS system 116. In general, the GPS system 116 is a spaced-based navigation system comprising a collection of satellites, launched and managed by the U.S. Air Force, for broadcast distribution of radio signals containing location and time information from any position on Earth. Although the geo-location system is described herein in reference to a GPS system, it should be understood that the GPS system is exemplary only and those having ordinary skill in the art would appreciate that other positioning systems, such as the Galileo system, Chinese Compass navigation system, and Indian Region Navigational Satellite System may be employed within the scope of the present teachings.

In various embodiments, the GPS functionality 114 is programmed into the tracking device 112, for example, as software stored in flash or other memory, storage, etc. and/or suitable hardware and firmware. The GPS functionality 114 allows the geographic position of the tracking device 112 to be precisely determined.

In various embodiments, the tracking device 112 is deployed associated with the shipment of a package. In various embodiments, the tracking device 112 functions to run an application with a processing functionality. This application relates to performing a process (e.g., a method implemented on tracking device 112 with its processor) for wireless accessing server 108 via network 110, accessing data related to the shipment of a package, and downloading the package shipment related data therefrom to the tracking device 112. Further, in various embodiments, the tracking device 112 has functionality to capture information relating to geo-location and sending the information to server 108, which can store it with data relating to the shipment of the package.

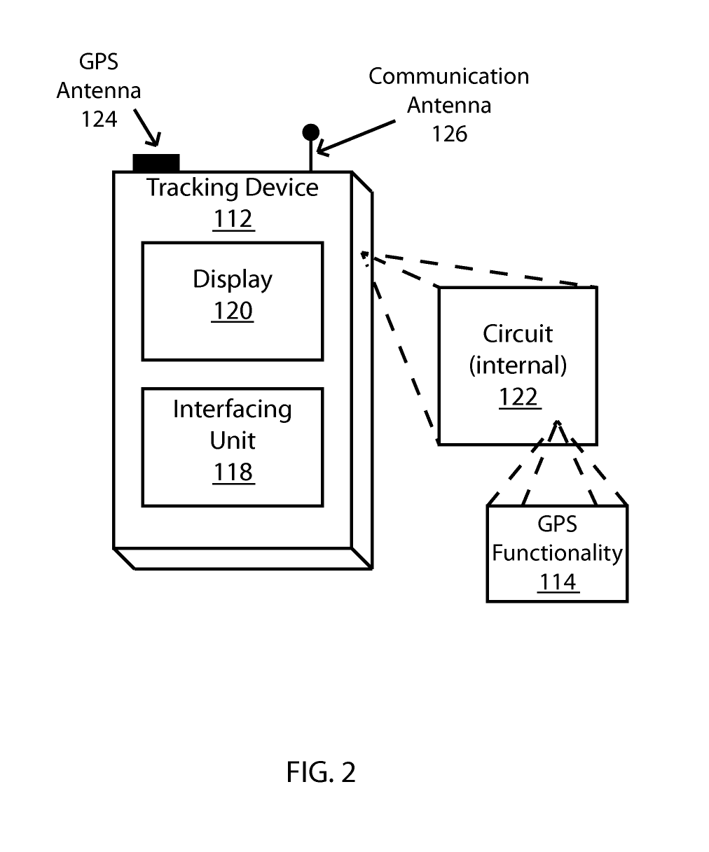

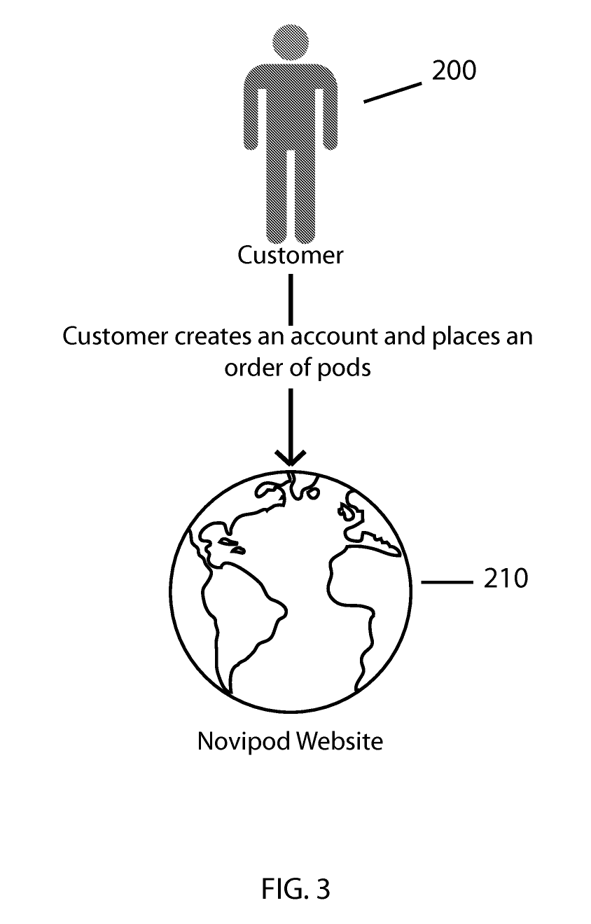

FIG. 2 depicts an example of the tracking device 112 according to the present invention. Tracking device 112 comprises, in various implementations, a GPS device that incorporates geo-location functionality 114, a small form factor computing device (e.g., computer) and/or other communications and/or networking functionality. In one embodiment, tracking device 112 may be enclosed within a protective envelope (FIGS. 3-7). Tracking device 112 may include an interface unit 118 for allowing a user to interface therewith, e.g., for operational, data entry, etc. functions. Interface unit 118 may comprise, in various implementations, an alphanumeric input device such as a numbers keyboard, a small form factor ‘QWERTY’ or other keyboard, buttons, knobs, switches etc. In various implementations, interface unit 118 operates with display 120 to allow graphical user interface (GUI) functionality, e.g., with interactive windows, fields, screen ‘buttons’, icons, etc. displayed thereon.

Component circuitry 122 within the tracking device 112 provides various functionalities for the device as is commonly known in the art. A GPS antenna 124 allows device 112 to access signals from the GPS or another geo-locating system, etc. (e.g., network 110 and GPS 116; FIG. 1). A communication antenna 126 (e.g., coupled with internal circuit 122) allows tracking device 112 to function wirelessly, e.g., for communicating with a network. In one embodiment, circuit 122 comprises GPS and/or other geo-locating functionality 114, which in one embodiment is software based and programmed into components of circuit 122.

In various embodiments, the geo-locating functionality 114 of tracking device 112 is provided with a modular system, which can be implemented in software, hardware, firmware and/or any combination of same. Such software comprises, in various embodiments, a computer readable medium having encoded therein (e.g., thereon, etc.) a code for causing a computer system to perform a method for a geo-locating function. Modules comprising the system for a geo-locating functionality can include components of circuit 122, programmed configurations of such components, and/or code stored with such components

As shown in FIG. 3, through the use of a client device, a customer 200, who wishes to send a package, creates an account in a software application, for example, by accessing a website 210 and placing a request order to receive one or more tracking devices 112. The request order is transmitted over the network 110 to the shipper client device 104. Through the use of the shipper client device 104, the shipper receives the request order and ships the requested tracking devices 112 to the customer 200. For example, each tracking device 112 is shipped to the customer 200 contained in a prepaid, two-part packaging.

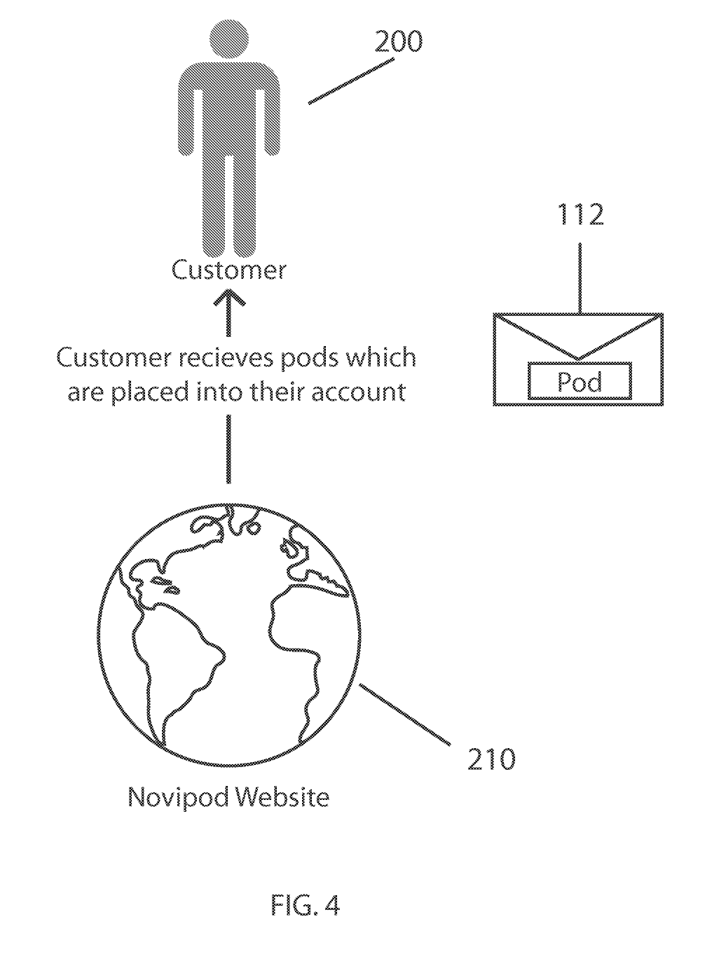

In FIG. 4, the customer 200 receives the tracking devices, which are assigned to the customer's software account. The customer then programs a destination location within the software of the tracking device 112. The destination location is defined by geo-fencing a geographic area. Typically, a geo-fence is a virtual perimeter or boundary defined for a real-world geographical area. The geo-fence works with location enabled or aware devices. If the location enabled device enters or exits a geo-fence that is associated with the location enabled device then some form of notification or alert may be triggered, either to the device or to one or more third parties.

Guest access is also created by the customer for shipment of the package in the software of the tracking device 112. Software alerts and security codes are created in the software and distributed to the intended recipient of the guest portal by messaging or data communications. Using the security code that is generated by the software, the recipient is granted access to the tracking device information collected during shipment journey in the software. After receiving the tracking devices 112, the customer can alter the packaging that contained the tracking devices by removing the customer shipping information.

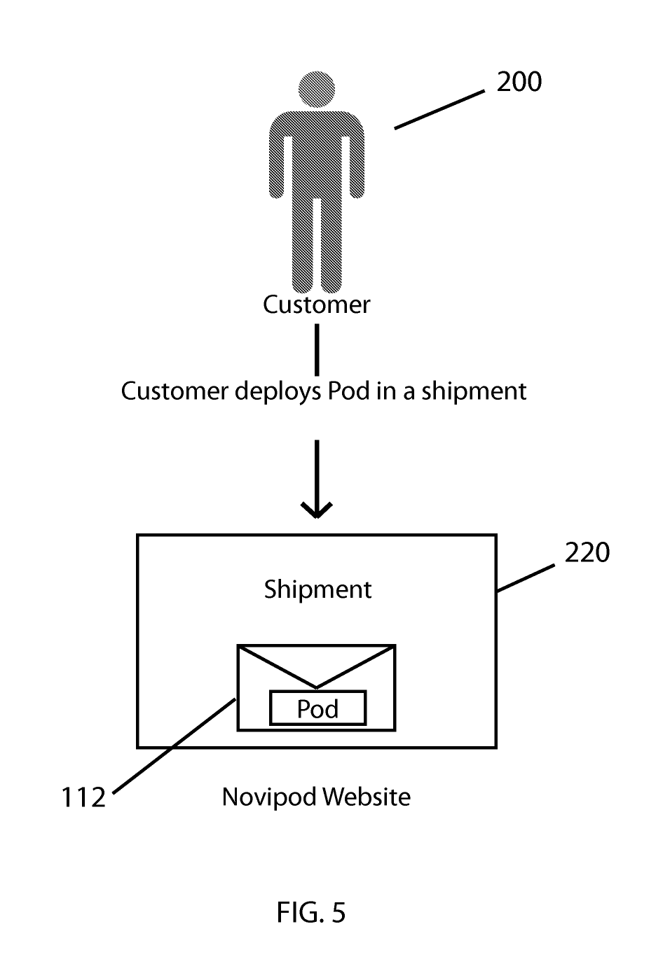

As shown in FIG. 5, the tracking device 112 is inserted into the customer's shipping package. The shipping package containing the tracking device 112 may be referred to as a “pod” 220. The pod 220 is tracked through its journey from origin to its destination by the software of the GPS functionality of the tracking device.

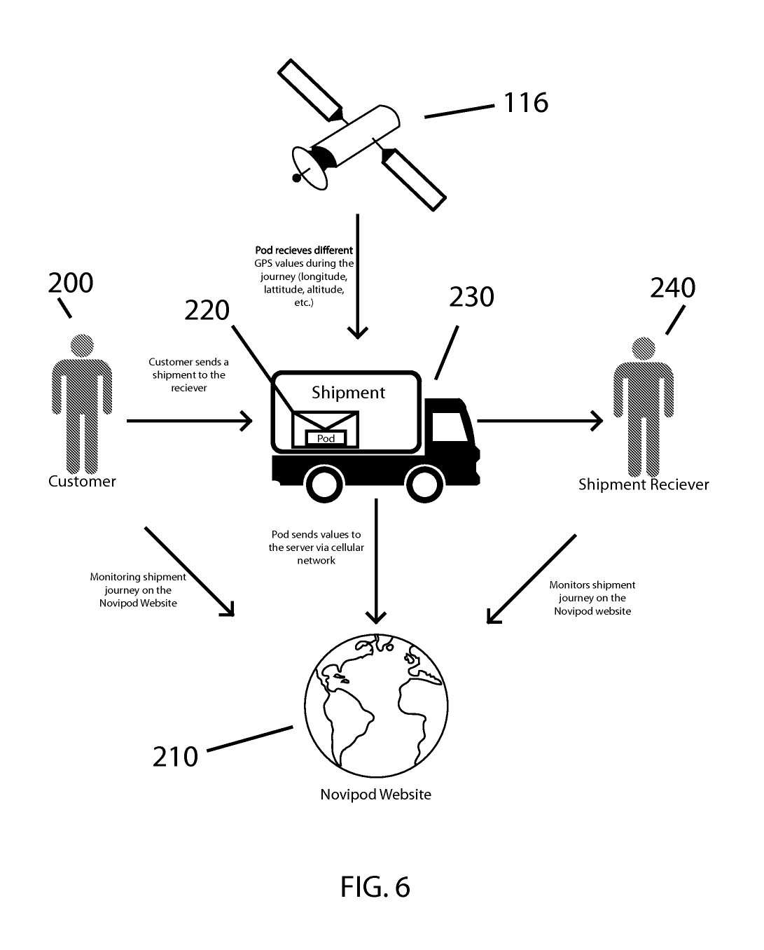

As shown in FIG. 6, the shipment is couriered by any means to its destination. The method of transporting the pod 220 may include air transportation, rail transportation, water transportation, ground transportation or a combination thereof at different stages within the journey. In the example shown in FIG. 5, the method of transporting the pod 220 is ground transportation by way of a truck 230. One or more sensors within the tracking device within the pod 220 may receive or transmit data associated with the pod. The data may be collected by the tracking device 112 and then transmitted to the server 108 via the network 110. The data may relate to information regarding latitude, longitude, altitude, velocity, direction, number of satellites, accuracy of data, temperature, impact, humidity, ambient light, and odor. The above list of data is merely exemplary and is not an exclusive one. Data about the shipment can be transmitted to the software using a secure communications standard through a wireless data network 110. After establishing various access rights, the server 108 may provide the collected data to various users via a client device. For example, the server 108 may host a website that may be accessible from the Internet. The sender, shipper, and/or receiver may access client computers or other compatible devices to view the website and the collected data about the pod 204. For example, the website may display the GPS location of the pod 204 and the additional collected data.

In geographical areas where the tracking device 114 within the pod 220 cannot gain access to the wireless data network or in the event the secure communications transport method is unavailable, the tracking device 114 can store all recorded data in an on-board memory module. When the tracking device 114 of the pod 220 reestablishes wireless data connectivity or reestablishes secure communications transport means, the device will transmit all stored data to the software in the server 108. In one embodiment, data reporting to the customer or recipient may be delayed by a specific duration defined within the software for shipment security reasons. For example, certain shipments may contain valuable contents that the sender may wish that the location during shipment remain secret in order to prevent theft.

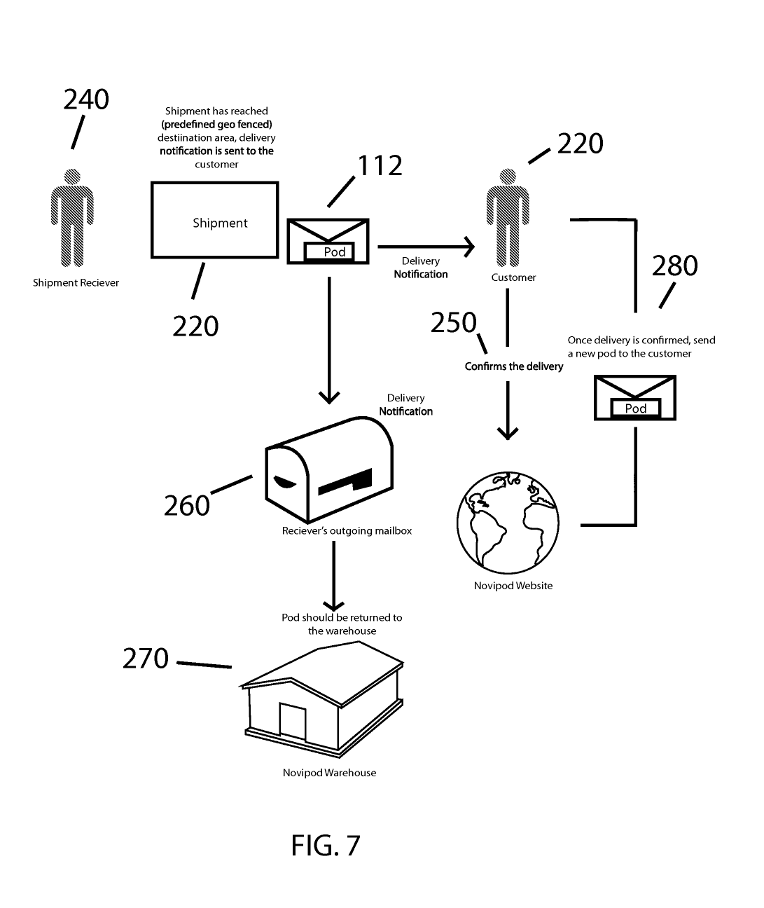

As shown in FIG. 7, when pod 220 reaches the recipient's destination within the defined geo-fenced area, a confirmation notification is triggered in the software. The software issues an alert to individuals on a predefined list, created by the sender that the shipment has reached its intended destination. In response to receiving the delivery alert, the customer/sender 220 may then send a confirmation 250 to confirm the delivery. Optionally, the recipient 240 can also confirm through the use of the guest portal that the shipment has reached the destination.

In the event of a misdirected or lost package, the customer can access the system and report that the shipment was not delivered to the intended recipient. Upon receiving such a report, the user or the system can activate a secondary mode of operation in the device 220. The secondary mode can provide real time data reporting to the customer, wherein the data reporting is not delayed by traditional predefined software reporting time delay. The device 220 may operate in the secondary mode for a specified period of time until the customer 220 deactivates this mode or until a specified time elapses. Another mode of operation is that the software signals programmed by the user or the system can set the device to operate in a power saving mode.

As shown in FIG. 7, once the pod 220 is received by the intended recipient 240, the recipient opens the shipment and removes the tracking device 112 from the shipment. The two-way mailing envelope of the device packaging contains detailed return instructions on the packaging as well as prepaid return postage and return address for returning the tracking device 112. In an alternative embodiment, rather than providing a two-way mailing envelope, labels containing the prepaid return postage and return address can be directly applied to the tracking device. Using the two-way mailing envelope or the return label, the recipient places the tracking device 112 in the outgoing mail 260. The tracking device 112 is returned to a warehouse location 270.

When the tracking device 112 is received at the warehouse 270, warehouse employees removes the tracking device 112 from the packaging or removes the attached return label from the tracking device 112. The warehouse employee may recharge the tracking device 112. Then, the tracking device 112 may be electrically connected to a software application, for example, by connecting a cable to a USB port of a computing device or wirelessly connecting to the software application. The software performs diagnostics checks on the returned tracking device 112 to ensure that the tracking device is functioning properly. If the tracking device 112 fails the diagnostics checks, the device is decommissioned. If tracking device 112 passes the diagnostic testing, tracking device is placed in the power saving mode.

Upon receipt of the delivery confirmation 250, the system automatically submits a replacement order and a new replacement tracking device 280 is shipped to the customer from warehouse 270. The replacement tracking device 280 is deployed by placing it in another two part mailer or directly attaching a return label to the tracking device for the next customer.

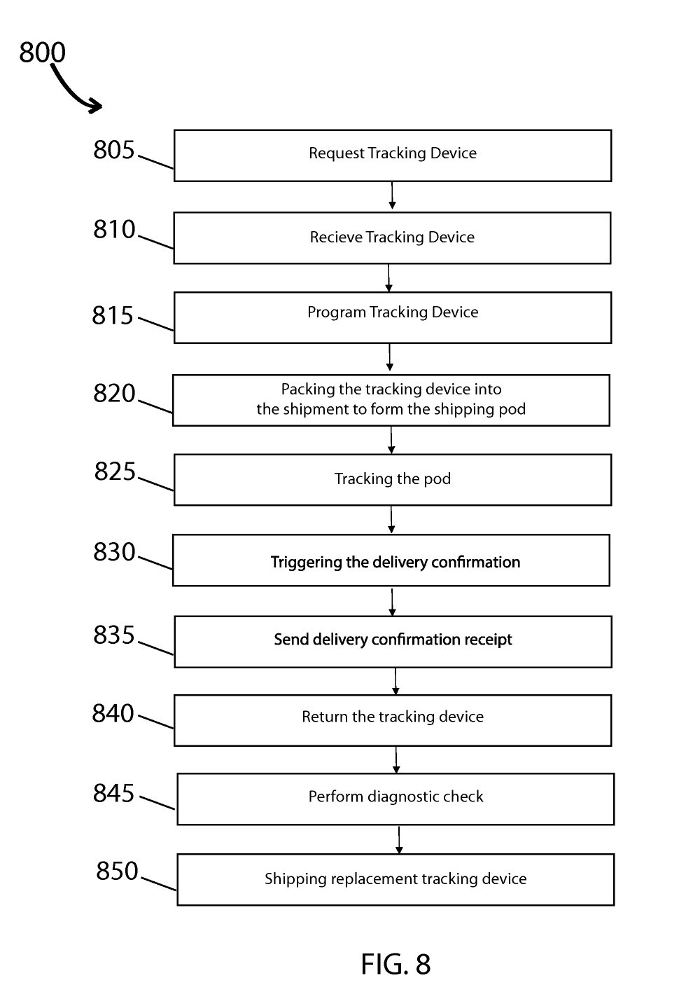

FIG. 8 is an exemplary flowchart of a method 800 for tracking a package throughout its journey. In Step 805, a customer accesses the website and requests a tracking device by creating an account. In Step 810, the customer receives the requested tracking device. In Step 815, the customer programs the tracking device and/or the website with information such as the destination location, geo-fencing geographic area data, guest access privileges, software alerts and security codes.

In Step 820, the tracking device is packaged into the shipment to form the pod. In Step 825, the pod is tracked throughout its journey providing data to the software. The data may be related to, for example, latitude, longitude, altitude, velocity, direction, number of satellites, accuracy of data, temperature, impact, humidity, ambient light, odor, etc.

In Step 830, a delivery confirmation may be trigged when the pod reaches the destination defined by the geo-fenced area. In Step 835, a receipt confirmation is sent, which confirms delivery of the pod. In Step 840, the tracking device is removed from the pod and returned to the warehouse, for example, via the outgoing mail.

In Step 845, diagnostic checks are performed on the returned tracking device to determine whether the device is functioning properly. In Step 850, a replacement tracking device is shipped to the customer.

The detailed descriptions may have been presented in terms of a software application executed on a computer or network of computers. These procedural descriptions and representations are the means used by those skilled in the art to most effectively convey the substance of their work to others skilled in the art. The embodiments of the invention may be implemented as apparent to those skilled in the art in hardware or software, or any combination thereof. The actual software code or hardware used to implement the present invention is not limiting of the present invention. Thus, the operation and behavior of the embodiments often will be described without specific reference to the actual software code or hardware components. The absence of such specific references is feasible because it is clearly understood that artisans of ordinary skill would be able to design software and hardware to implement the embodiments of the present invention based on the description herein with only a reasonable effort and without undue experimentation.

A procedure is described herein, and generally, conceived to be a sequence of operations leading to a desired result. These operations comprise physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, objects, attributes or the like. It should be noted, however, that all of these and similar terms are to be associated with the appropriate physical quantities and are merely convenient labels applied to these quantities.

Further, the manipulations performed are often referred to in terms, such as adding, comparing, or calculating, which are commonly associated with mental operations performed by a human operator. No such capability of a human operator is necessary, or desirable in most cases, in any of the operations of the present invention described herein; the operations are machine operations. Useful machines for performing the operations of the present invention include general purpose digital computers, special purpose computer or similar devices.

Each operation of the method may be executed on any general computer, such as a mainframe computer, personal computer or the like and pursuant to one or more, or a part of one or more, program modules or objects generated from any programming language, such as C++, Java, FORTRAN, etc. And still further, each operation, or a file, module, object or the like implementing each operation, may be executed by special purpose hardware or a circuit module designed for that purpose. For example, the invention may be implemented as a firmware program loaded into non-volatile storage or a software program loaded from or into a data storage medium as machine-readable code, such code being instructions executable by an array of logic elements such as a microprocessor or other digital signal processing unit. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on.

In the case of diagrams depicted herein, they are provided by way of example. There may be variations to these diagrams or the operations (or operations) described herein without departing from the spirit of the invention. For instance, in certain cases, the operations may be performed in differing order, or operations may be added, deleted or modified.

An embodiment of the invention may be implemented as an article of manufacture comprising a computer usable medium having computer readable program code means therein for executing the method operations of the invention, a program storage device readable by a machine, tangibly embodying a program of instructions executable by a machine to perform the method operations of the invention, or a computer program product. Such an article of manufacture, program storage device or computer program product may include, but is not limited to, CD-ROM, CD-R, CD-RW, diskettes, tapes, hard drives, computer system memory (e.g. RAM or ROM), and/or the electronic, magnetic, optical, biological or other similar embodiment of the program (including, but not limited to, a carrier wave modulated, or otherwise manipulated, to convey instructions that can be read, demodulated/decoded and executed by a computer). Indeed, the article of manufacture, program storage device or computer program product may include any solid or fluid transmission medium, whether magnetic, biological, optical, or the like, for storing or transmitting signals readable by a machine for controlling the operation of a general or special purpose computer according to the method of the invention and/or to structure its components in accordance with a system of the invention.

An embodiment of the invention may also be implemented in a system. A system may comprise a computer that includes a processor and a memory device and optionally, a storage device, an output device such as a video display and/or an input device such as a keyboard or computer mouse. Moreover, a system may comprise an interconnected network of computers. Computers may equally be in stand-alone form (such as the traditional desktop personal computer) or integrated into another apparatus (such as a cellular telephone).

The system may be specially constructed for the required purposes to perform, for example, the method of the invention or it may comprise one or more general purpose computers as selectively activated or reconfigured by a computer program in accordance with the teachings herein stored in the computer(s). The system could also be implemented in whole or in part as a hard-wired circuit or as a circuit configuration fabricated into an application-specific integrated circuit. The invention presented herein is not inherently related to a particular computer system or other apparatus. The required structure for a variety of these systems will appear from the description given.

Those skilled in the art will also appreciate that various adaptations and modifications of the preferred and alternative embodiments described above can be configured without departing from the scope and spirit of the disclosure. Therefore, it is to be understood that, within the scope of the appended claims, the disclosure may be practiced other than as specifically described herein.

We claim:

1. An tracking system comprising:
a reusable tracking device associated with a shipment of a package, wherein the reusable tracking device is configured to be separable from the package and returned for reuse when the package reaches a predefined destination, and the reusable tracking device comprises:
a sensor that detects sensor data about the reusable tracking device;
memory that stores data including the sensor data collected by the sensor; and
a processor associated with the reusable tracking device to determine a location of the reusable tracking device based on the data; and
an input/output device configured to receive the data from the reusable tracking device.

2. The system of claim 1, wherein a two-way mailing package is employed to return the reusable tracking device.

3. The system of claim 1, wherein a return label is employed to return the reusable tracking device.

4. The system of claim 1, wherein the location of the reusable tracking device is determined by accessing data from a positioning system.

5. The system of claim 4, wherein the positioning system comprises at least one of a Global Positioning System (GPS), Chinese Compass Navigation System, and Indian Region Navigational Satellite System.

6. The system of claim 4, further comprising a tracking facility operable to receive the data regarding the reusable tracking device.

7. The system of claim 6, wherein the tracking facility periodically receives the data regarding the reusable tracking device.

8. The system of claim 6, wherein the tracking facility dynamically receives real-time data regarding the reusable tracking device when the shipment is misdelivered or when the reusable tracking device exits a predefined geo-fenced geographical area.

9. The system of claim 6, wherein the sensor data relates at least one of latitude information, longitude information, altitude information, velocity information, direction information, number of satellites information, accuracy of data information, temperature information, impact information, humidity information, ambient light information and odor information.

10. The system of claim 9, wherein access to the data is selectively granted to users based on assigned access rights and privileges.

11. The system of claim 1, wherein a destination location of the shipment is defined by geo-fencing a geographic area.

12. The system of claim 1, wherein the sensor data triggers a delivery confirmation alert when the shipment reaches a predefined destination location.

13. The system of claim 1, wherein a diagnostic check is performed on the reusable tracking device when the reusable tracking device is returned.

14. A method of tracking a package comprising:
providing a reusable tracking device associated with a shipment of a package;
separating the reusable tracking device from the package and returning the reusable tracking device for reuse when the package reaches a predefined destination;
detecting sensor data about the reusable tracking device;
storing, in a memory, data including the sensor data collected by the sensor; and
determining a location of the reusable tracking device based on the data.

15. The method of claim 14, wherein the step of determining the location of the reusable tracking device further comprises accessing data from a positioning system.

16. The method of claim 15, further comprising receiving the data regarding the reusable tracking device at a tracking facility.

17. The method of claim 16, further comprising periodically receiving the data regarding the reusable tracking device at the tracking facility.

18. The method of claim 16, further comprising dynamically receiving at the tracking facility real-time data regarding the reusable tracking device when the shipment is misdelivered or when the reusable tracking device exits a predefined geo-fenced geographical area.

19. The method of claim 14, further comprising defining a destination location of the shipment by geo-fencing a geographic area.

20. The method of claim 14, further comprising performing a diagnostic check on the reusable tracking device when the reusable tracking device is returned.
